(19) United States
(12) Patent Application Publication
(10) Pub. No.: US 2015/0185893 A1
(43) Pub. Date: Jul. 2, 2015

(54) TOUCH PANEL AND METHOD FOR MANUFACTURING SAME

(71) Applicant: HON HAI PRECISION INDUSTRY CO., LTD., New Taipei (TW)

(72) Inventors: CHIN-YANG WU, Zhubei (TW); TEN-HSING JAW, Zhubei (TW)

(21) Appl. No.: 14/576,223

(22) Filed: Dec. 19, 2014

(30) Foreign Application Priority Data
Dec. 26, 2013 (TW) 102148529

(51) Int. Cl. G06F 3/041

(52) U.S. Cl. CPC G06F 3/041; G06F 2203/04111; G06F 2203/04103

(57) ABSTRACT

A method for manufacturing a touch panel includes the following procedures. A base plate is provided. A conductive layer is formed on the base plate. The conductive layer is etched to form a plurality of first and second electrodes which are alternatively arranged according to columns on the base plate and insulated from each other, and the first electrodes in a column along a first direction are electrically coupled to each other. A plurality of insulated layers is formed on the first and second electrodes. A plurality of conductive rings coupled to each other in an order are formed on each insulated layer via an ink jet printing method to electrically interconnect with each neighboring second electrodes in a column along the second direction intersecting the first direction. The present disclosure further provides a touch panel manufactured by the method.

### FIELD

The subject matter herein generally relates to touch panels, and in particular to a method for manufacturing a touch panel with a single conductive layer.

### BACKGROUND

Touch panels are input devices that allow manual instruction to be input by touching the screen.

### BRIEF DESCRIPTION OF THE DRAWINGS

Implementations of the present technology will now be described, by way of example only, with reference to the attached figures.

FIG. 1 is a top plan view of an embodiment of a touch panel.

FIG. 2 is an enlarged view of area II of FIG. 1.

FIG. 3 is a flowchart for manufacturing the touch panel of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “inside” indicates that at least a portion of a region is partially contained within a boundary formed by the object. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

A touch panel can include a base plate, a conductive layer, a number of insulated layers, a number of bridge connectors. The conductive layer can formed on the base plate, and can define a number of first and second electrodes which are alternatively arranged according to columns and insulated from each other. The first electrodes in a column along a first direction can be electrically coupled to each other. The second electrodes in a column along a second direction intersecting the first direction can have separated patterns. The insulated layers can be formed on the first and second electrodes. Each insulated layer can overlap a portion of each two neighboring second electrodes in a column along the second direction, and a portion of each two first electrodes positioned adjacent to the two neighboring second electrodes. The bridge connectors can be formed on the insulated layers to electrically interconnect with the neighboring two electrodes in a column along the second direction. Each bridge connector can include a number of conductive rings which is coupled to each other in an order. Each conductive ring can be composed conductive nanoparticles of ink.

A method for manufacturing a touch panel can include: providing a base plate; forming a conductive layer on the base plate; etching the conductive layer to form a number of first and second electrodes which are alternatively arranged according to columns on the base plate and insulated from each other, the first electrodes in a column along a first direction being electrically coupled to each other, the second electrodes in a column along a second direction intersecting the first direction having separated patterns; forming a number of insulated layers on the number of first and second electrodes, each insulated layer overlapping a portion of each two neighboring second electrodes in a column along the second direction and a portion of each two first electrodes positioned adjacent to the two neighboring second electrodes; and forming a number of conductive rings coupled to each other in an order on each insulated layers via an ink jet printing method to electrically interconnect with the neighboring second electrodes in a column along the second direction.

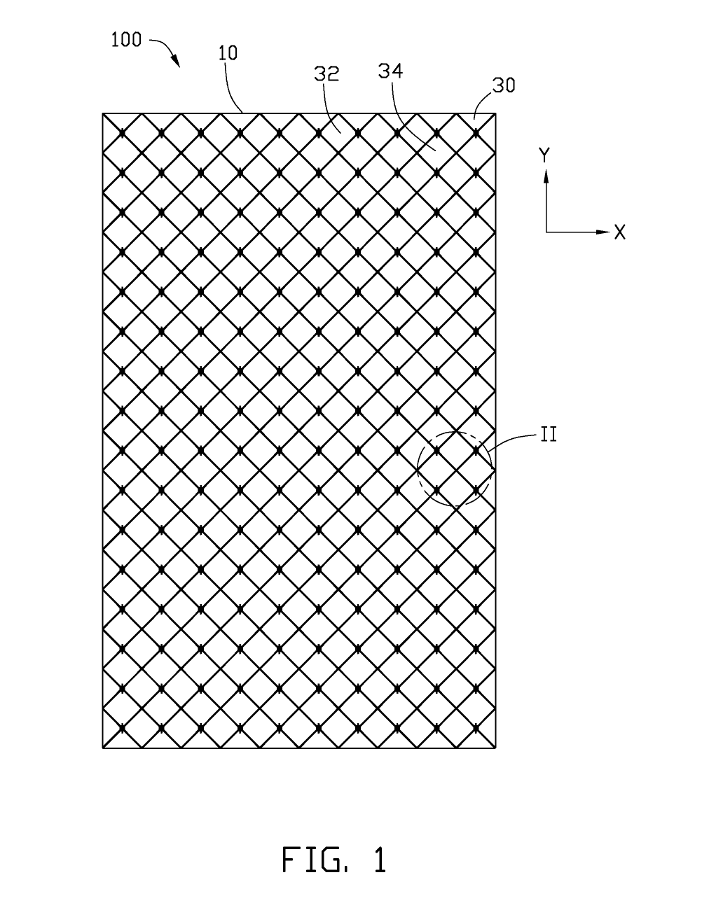

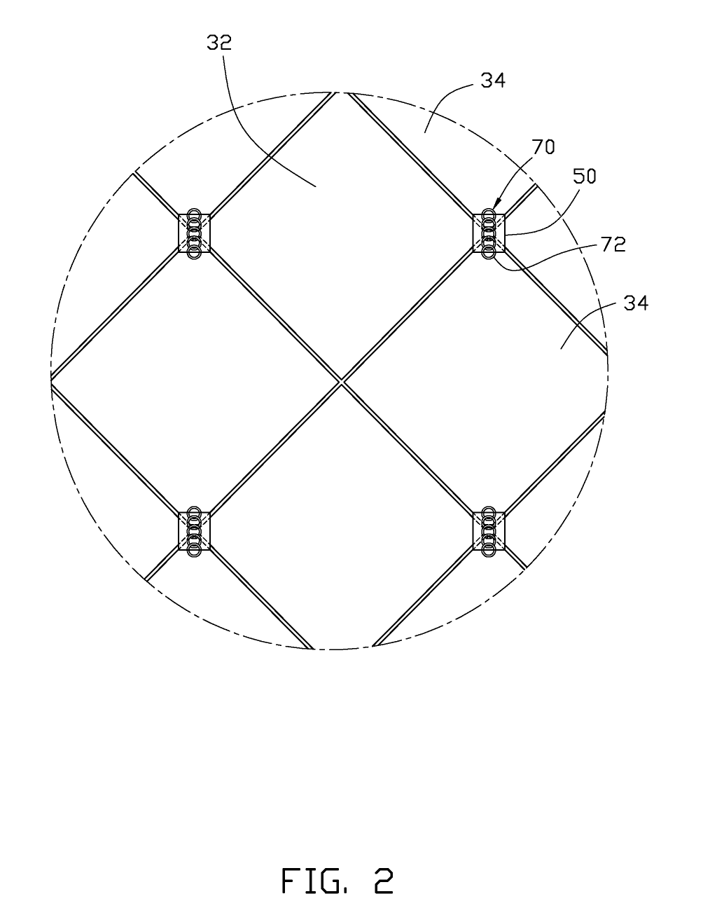

FIGS. 1 and 2 illustrate an embodiment of a touch panel 100. The touch panel 100 can include a base plate 10, a conductive layer 30, a number of insulated layers 50, and a number of bridge connectors 70. In at least one embodiment, the base plate 10 can be made of transparent insulation materials, such as transparent glass, or polyethylene terephthalate (PET).

The conductive layer 30 can define a number of first electrodes 32, and a number of second electrodes 34 arranged between and insulated from the first electrodes 32. The first electrodes 32 and the second electrodes 34 can be alternatively arranged according to columns, and arranged as a matrix. In at least one embodiment, the first electrodes 32 and the second electrodes 34 can be respectively formed in mesh structures on the base plate 10. The first electrodes 32 can be drive electrodes, electrically coupled to each other in a column along a first direction X to form a drive electrode column, and insulated from each other in a column along a second direction Y which intersects the first direction X. The second electrodes 34 can be sensor electrodes, and dispersed between the first electrodes 32 to have separate patterns in a column along the second direction Y, thereby the second electrodes 34 can be insulated from the first electrodes 32 and can be insulated from each other. The second electrodes 34 can be electrically coupled to each other in a second direction Y via the bridge connectors 70 to form a sensor electrode column. In at least one embodiment, the first electrodes 32 can be sensor electrodes, and the second electrode 34 can be drive electrodes.

The conductive layer 30 can be formed on the base plate 10 by a sputtering coating method. The first electrodes 32 and the second electrodes 34 can be formed on the base plate 10 by etching the conductive layer 30. The conductive layer 30 can be made of transparent materials, such as indium tin oxide (ITO) or indium zinc oxide (IZO). In at least one embodiment, the conductive layer 30 can be made of metal, such as gold, silver, copper, aluminum, or molybdenum.

The insulated layers 50 can be patterned on the first electrodes 32 and the second electrodes 34. Each insulated layer 50 can overlap a portion of each two neighboring second electrodes 34 in a column along the second direction Y to provide an insulation property. Each insulated layer 50 can overlap a portion of each two first electrodes 32, which can be positioned adjacent to the two neighboring second electrodes 34. Each insulated layer 50 can be substantially rectangular in shape. The width of each insulated layer 50 can be about 100 μm to 300 μm, and the length of each insulated layer 50 can be about 300 μm to 600 μm. The insulated layers 50 can be made of transparent organic materials deposed via an ink jet printing method, which are thermosetting or UV-curing, such as poly(4 vinyl phenol), polyimide, aromatic ether, or aromatic hydrocarbon, for example. In at least one embodiment, the insulated layers 50 can be in other shapes, such as triangular, hexagonal, or circular, so long as each insulated layer 50 can overlap a portion of each two neighboring second electrodes 34 along the second direction Y, and a portion of each two first electrodes 32 positioned adjacent to the two neighboring second electrodes 34

The bridge connectors 70 can be formed on the insulated layers 50. Each bridge connector 70 can be formed on one insulated layer 50, and two ends of the bridge connector 70 can protrude out from the corresponding insulated layer 50 to be electrically coupled to the two neighboring second electrodes 34 in a column along the second direction Y. Thereby, the second electrodes 34 arranged in a column along the second direction Y can be electrically coupled to each other via the bridge connectors 70. Each bridge connector 70 can include a number of conducting rings 72 coupled to each other in order. The conducting rings 72 can be made of ink doped with metal nanoparticles to provide a conduction property, and formed by the ink jet printing method. An inkjet printer (not shown) can spray a number of ink droplets on the insulated layers 50 in a step of forming the conducting rings 72. Each ink droplet can be substantially circled, and an evaporation rate of the ink droplet located on the peripheral area of the circle can be higher than that of the ink droplet located on the central area of the circle. Thus, the ink located on the central area of the circle can flow to the peripheral area of the circle, and the metal nanoparticles can sediment in the peripheral area of the circle to form the conductive ring 72. Each ink droplet can be sprayed on one insulated layer 50, and then can be cured to form one conductive ring 72. The conductive rings 72 coupled to each other in an order can be sintered at high temperature to be electrically coupled to the two neighboring second electrodes 34.

Each bridge connector 70 can include five conductive rings 72 coupled to each other in an order. Each conductive ring 72 can have an external diameter of about 150 μm, a diameter difference between inside and external diameter of about 5 μm to 10 μm, and a thickness of about 300 μm. In at least one embodiment, the external diameter of each conductive ring 72 can be in a range from 50 μm to 200 μm, the size of each insulated layer 50, and the number and the arrangement of the conductive rings 72 of each bridge connector 70 can be changed as needed, so long as the bridge connectors 70 can be electrically coupled to the two neighboring second electrodes 34 and insulated from the two first electrodes 32 positioned adjacent to the two neighboring second electrodes 34. The conductive rings 72 can be made of ink doped with metal nanoparticles, such as silver nanoparticles, gold nanoparticles, or copper nanoparticles. In at least one embodiment, the conductive rings 72 can be made of ink doped with nonmetal conductive particles, such as carbon nano tube (CNT) particles, or grapheme particles.

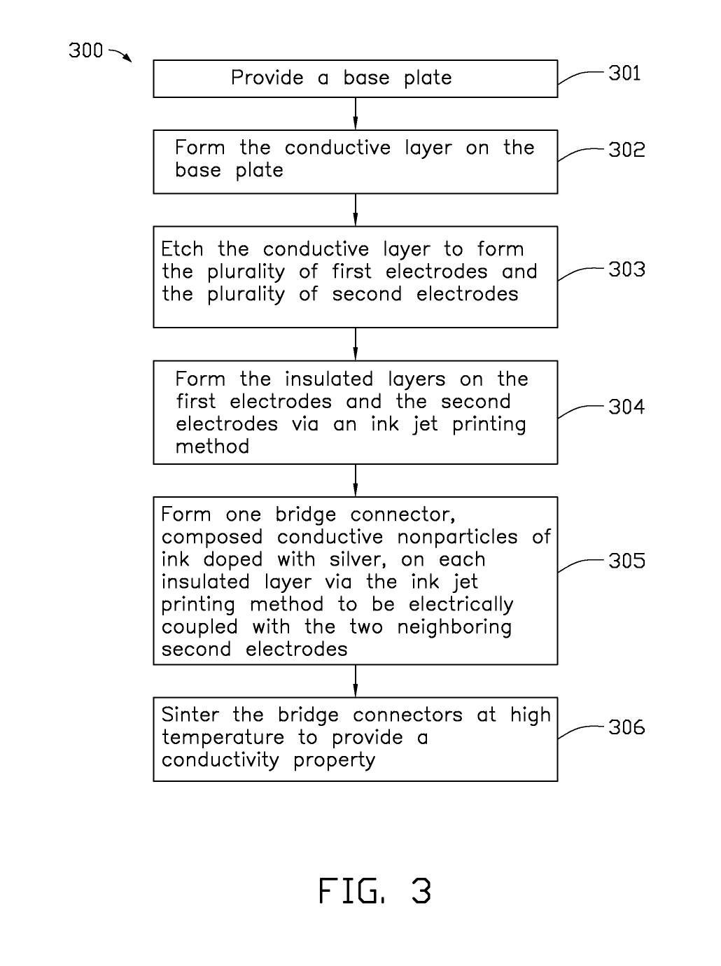

FIG. 3 illustrates the method for manufacturing the touch panel in accordance with an example embodiment. The method 300 is provided by way of example, as there are a variety of ways to carry out the method. The method 300 described below can be carried out using the configurations illustrated in FIGS. 1-2, for example, and various elements of these figures are referenced in explaining example method 300. Each block shown in FIG. 3 represents one or more processes, methods or subroutines, carried out in the example method 300. Furthermore, the illustrated order of blocks is by example only and the order of the blocks can change according to the present disclosure. Additional blocks may be added or fewer blocks may be utilized, without departing from this disclosure. The example method 300 for manufacturing the touch panel can begin at block 301.

At block 301, a base plate is provided. In at least one embodiment, the base plate 10 can be made of transparent insulation materials, such as transparent glass, quartz, or organic polymers.

At block 302, the conductive layer is formed on the base plate. In at least one embodiment, the conductive layer 30 can be coated on the base plate 10 by a sputtering coating method.

At block 303, the plurality of first electrodes and the plurality of second electrodes are formed via etching the conductive layer.

The first electrodes 32 and the second electrodes 34 can be respectively formed in mesh structures on the base plate 10, alternatively arranged according to columns, and insulated from each other. The first electrodes 32 can be electrically coupled to each other in a column along the first direction X, and the first electrodes 32 in a column along the second direction Y can be insulated from each other. The second electrodes 34 can be dispersed between the first electrodes 32, and can be formed in separate patterns in a column along the second direction Y. Thereby, the second electrodes 34 can be insulated from each other. In at least one embodiment, the conductive layer 30 can be etched via a chemical etching method.

At block 304, the insulated layers are patterned on the first electrodes and the second electrodes via an ink jet printing method.

Each insulated layer 50 can be located on a portion of each two neighboring second electrodes 34 in a column along the second direction Y, and a portion of each two first electrodes 32 positioned adjacent to the two neighboring second electrodes 34. In at least one embodiment, the insulated layers 50 can be attached to the first electrodes 32 and the second electrodes 34.

At block 305, one bridge connector, composed conductive nanoparticles of ink doped with silver, is formed on each insulated layer via the ink jet printing method, and electrically coupled with the two neighboring second electrodes.

The ink droplets can be spared on the insulated layer 50 via the ink jet printing method, and then the ink droplets can be cured. Because each ink droplet can be substantially circled, the evaporation rate of the ink droplet located on the peripheral area of the circle can be higher than that of the ink droplet located on the central area of the circle during the step of curing the ink droplet. In this way, he ink located on the central area of the circle can flow to the peripheral area of the circle during the step of curing the ink droplet, and the metal nanoparticles can sediment in the peripheral area of the circle to form the conductive ring 72. The diameter difference between inside and external diameter of each conductive ring 72 can be about 5 μm to 10 μm. The ink droplets can be cured by one or more methods selected from the group consisting of room temperature curing, high temperature curing, and ultraviolet curing. In at least one embodiment, the conductive rings 72 can be composed conductive particles of ink doped with metal or nonmetal, such as ink doped with gold, ink doped with copper, or ink doped with grapheme.

At block 306, the bridge connectors are sintered at high temperature to provide a conductive property, thus the second electrodes in a column along the second direction Y are electrically coupled to each other via the bridge connectors.

The metal nanoparticles dispersed in each conductive ring 72 can form a compact structure via the high temperature sintering method, in other words, the metal nanoparticles can be in close contact with each other, thus the conductive rings 72 can have a conductivity property. In at least one embodiment, when the bridge connectors 70 are made of ink doped with nonmetal nanoparticles, such as grapheme, the bridge connectors 70 can be sintered at low temperature, or do not need to be sintered to provide the conductive property.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure, as defined by the appended claims.

What is claimed is:

1. A touch panel comprising:
a base plate;
a conductive layer formed on the base plate and defining a plurality of first and second electrodes which are alternatively arranged according to columns and insulated from each other, the first electrodes in a column along a first direction being electrically coupled to each other, and the second electrodes in a column along a second direction intersecting the first direction having separated patterns;
a plurality of insulated layers formed on the plurality of first and second electrodes, each insulated layer overlapping a portion of each two neighboring second electrodes in a column along the second direction and a portion of each two first electrodes positioned adjacent to the two neighboring second electrodes; and
a plurality of bridge connectors formed on the plurality of insulated layers to electrically interconnect with the neighboring second electrodes in a column along the second direction, each bridge connector comprising a plurality of conductive rings which is coupled to each other in an order, each conductive ring being composed conductive nanoparticles of ink.

2. The touch panel of claim 1, wherein each insulated layer has a width of about 100 μm to 300 μm and a length of 300 μm to 600 μm, each bridge connector comprises five conductive rings with an external diameter of 150 μm.

3. The touch panel of claim 1, wherein a diameter difference between inside and external diameter of each conductive ring is about 5 μm to 10 μm.

4. The touch panel of claim 1, wherein each conductive ring is made of one or more materials selected from the group consisting of ink doped with gold nanoparticles, ink doped with silver nanoparticles, and ink doped with copper nanoparticles.

5. The touch panel of claim 1, wherein each conductive ring is made of one or more materials selected from the group consisting of ink doped with carbon nano tube particles, and grapheme particles.

6. The touch panel of claim 1, wherein each insulated layer is made of transparent organic materials deposed via an ink jet printing method, such as thermosetting or UV-curing.

7. A method for manufacturing a touch panel, the method comprising:
providing a base plate;
forming a conductive layer on the base plate;
etching the conductive layer to form a plurality of first and second electrodes which are alternatively arranged according to columns on the base plate and insulated from each other, the first electrodes in a column along a first direction being electrically coupled to each other, the second electrodes in a column along a second direction intersecting the first direction having separated patterns;
forming a plurality of insulated layers on the plurality of first and second electrodes, each insulated layer overlapping a portion of each two neighboring second electrodes in a column along the second direction and a portion of each two first electrodes positioned adjacent to the two neighboring second electrodes; and
forming a plurality of conductive rings coupled to each other in an order on each insulated layers via an ink jet printing method to electrically interconnect with the neighboring second electrodes in a column along the second direction.

8. The method of claim 7, wherein the plurality of insulated layers are formed by the method of ink jet printing.

9. The method of claim 7, wherein the step of forming the plurality of conductive rings comprising: spraying ink droplets on the insulated layers in an order via the ink jet printing method, and solidifying the ink droplets to form the conductive rings.

10. The method of claim 9, wherein the ink droplets is solidified by one or more methods selected from the group consisting of a method of room temperature curing, a method of high temperature curing, and a method of ultraviolet curing.

11. The method of claim 7, wherein the conductive rings are made of ink doped with metal nanoparticles, and the method further comprises: sintering the conductive rings.
